(19) United States
(12) Patent Application Publication
(10) Pub. No.: US 2016/0247139 A1
(43) Pub. Date: Aug. 25, 2016

(54) Centralized Receipt Repository

(71) Applicant: Stefan David Kraus, Macon, GA (US)

(72) Inventor: Stefan David Kraus, Macon, GA (US)

(21) Appl. No.: 14/627,407

(22) Filed: Feb. 20, 2015

(51) Int. Cl. G06Q 20/32; G06F 17/30; G06Q 20/40

(52) U.S. Cl. CPC G06Q 20/3223; G06Q 20/40; G06F 17/30864; G06F 17/30312; G06F 17/30244

(57) ABSTRACT

The system tracks transaction information as it goes to the acquiring network; where it is associated with the card type, matched to the issuer, and sent via the IS08583 authorization stream for approval. Elements are extracted from the IS08583 message to represent the payment receipt then sent to and stored in a centralized payment receipt repository (CRR). A real-time record of the payment is recorded and a message confirmation notice is sent to the mobile device. The message confirmation sent to the mobile device contains merchant specific data. The real-time message contains transaction details and allows for additional functionality to classify the transaction as a “business” or “personal” expense or other expense type. Additional functionality allows a user to capture a photo of the payment receipt. All of the transaction, classification information, payment receipt photographs, and history is stored on backend servers and can be accessed via a user's account. The system produces reports from the stored information directly on the mobile device, or to any computer or device, which has internet or networking capabilities. The system will create both personal and business reports. A user can access the stored and classified information and save it to a predefined format using the mobile interface. The user can export this information in a variety of formats. The main functionality of this invention is to capture transaction history, create digital images of payment receipts, organize the payment receipts by category or other designated purpose reports based on stored transaction and payment receipt information, and export the report information to a file in any data format with separation, saves time, and enable a user to have an instant accessible location to view and manage payment receipt.

### BACKGROUND

The subject matter of this patent application relates to a centralized payment receipt repository managed via a mobile device with photographic capabilities or any other device with the ability to communicate on a network, and/or that has the ability and connectivity to communicate with the invention. These mechanisms for communication are generically referred to herein as “mobile device”. This invention has the ability to save, organize, create reports, and export a saved report file in any data format with separation. This invention also provides printing functionality and the ability to export. This invention simplifies the process of storing, organizing, and keeping track of payment receipts.

### SUMMARY OF THE INVENTION

This invention makes way for a user to archive payment receipt data, classify the payment receipts by category or other designated purpose (i.e. business or personal), capture and pair a payment receipt image to the stored payment receipt data, create reports (i.e. expense report), and export report files for the stored transaction information and payment receipt images. These reports can be submitted to the IRS, to the person's place of work for reimbursements, used as supporting documents, etc.

This invention solves the problem of keeping track and organizing payment receipts for a variety of different purposes. By capturing transaction history, creating a digital image of a payment receipt, having the ability to organize the payment receipts by category or other designated purpose, and having the ability to export the images and information to a file in any data format with separation, this invention saves time and enables a user to have an instant accessible location to view and manage payment receipts.

### BRIEF DESCRIPTION OF THE DRAWINGS

FIG. 1. FIG. 1 shows the communication pathways from initiated transaction to the payment receipt repository.

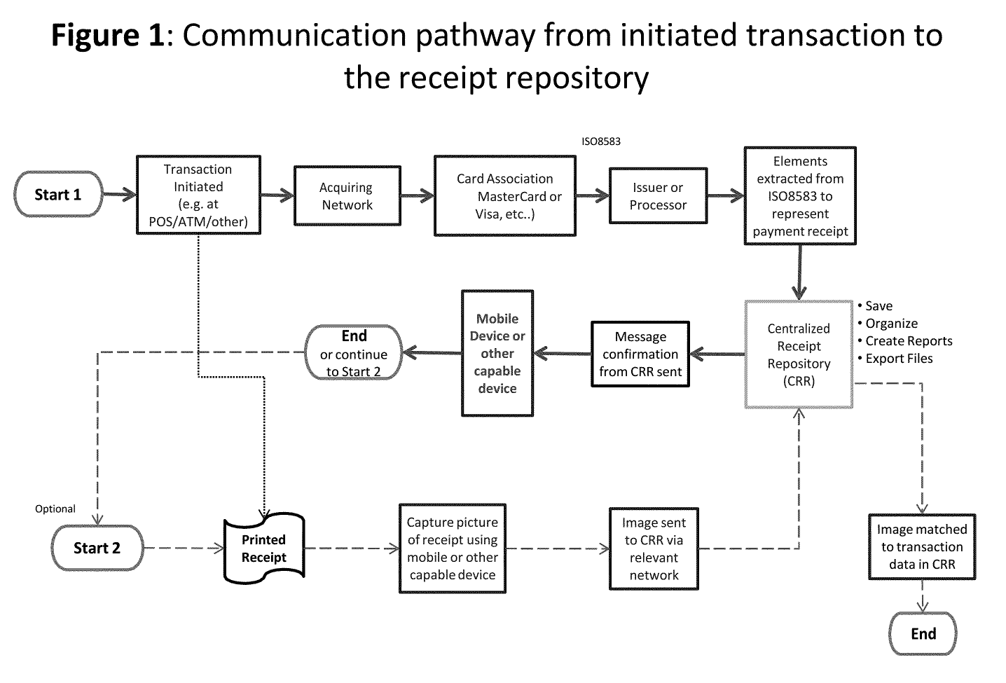

### DETAILED DESCRIPTION AND BEST MODE OF IMPLEMENTATION

This invention is a system launched when a transaction is initiated using a payment instrument (i.e. at POS/ATM/other). The transaction information goes to the acquiring network where it is associated with the card type, matched to the issuer, and sent via the ISO8583 authorization stream for approval. Elements are extracted from the ISO8583 message to represent the payment receipt then sent to and stored in a centralized payment receipt repository (CRR). A real-time record of the payment is recorded and a message confirmation notice is sent to the mobile device. The message confirmation received on the mobile device contains the merchant name, the dollar value, the date, and time of the transaction, and any other required data.

Along with the real-time message containing transaction details, are buttons that become available. These buttons contain functionality to classify the transaction as a “business” or “personal” expense or other expense type. The user would then make a selection to archive the payment receipt accordingly.

Alternatively, additional functionality allows a user to capture a photo—a digital “snapshot” of the payment receipt that was printed at the point of sale (using a mobile device with camera capabilities) at the time the transaction detail message is received.

All of the transaction, classification information, payment receipt photographs, and history is stored on backend servers (that can be hosted anywhere, including the cloud or other) and can be accessed via a user's account.

The system can also produce reports (i.e. expense) from the stored information directly on the mobile device, or to any computer or device, which has internet or networking capabilities. The system can create both personal and business reports. These reports can be submitted to the IRS, to the person's place of work for reimbursements, used as supporting documents, etc.

The system also has report export functionality. A user can access the stored and classified information and then save it to predefined format using the mobile interface. The user can export (download) this information in a variety of formats, including Comma Separated Values, ZIP files, Excel files, or any other applicable data format to any device or account to create detailed expense reports, backed by photographic evidence of payment receipts.

The main functionality of this invention is to capture transaction history, create digital images of payment receipts, organize the payment receipts by category or other designated purpose (i.e. business, personal, or other), create reports based on stored transaction and payment receipt information, and export the report information to a file in any data format with separation, saves time, and enables a user to have an instant accessible location to view and manage payment receipt.

1. A system comprising: a data warehouse which stores information about the user's transactional receipts.

2. The invention of claim 1 further comprises: a logic engine reads the ISO 8583 authorization messages from the payment instrument transaction.

3. The invention of claim 2 wherein the logic engine analyzes the transaction and applies the applicable tag, being business or personal.

4. The invention of claim 2 wherein the camera application on the user phone allows for submitting a picture of the receipt.

5. The invention of claim 4 wherein the photo of the receipt is stored in the database.

6. The invention of claim 1 allows for the output of excel spreadsheets of data stored on the database.

6. The invention of claim 1 resides on Amazon Web Services.
